(19) United States
(12) Patent Application Publication
(10) Pub. No.: US 2013/0024390 A1
(43) Pub. Date: Jan. 24, 2013

(54) Method and System of Matching Transportation Routes online

(71) Applicant: Ilya Zlobinsky, Brooklyn, NY (US)

(72) Inventor: Ilya Zlobinsky, Brooklyn, NY (US)

(21) Appl. No.: 13/189,297

(22) Filed: Jul. 22, 2011

(51) Int. Cl. G06Q 99/00

(52) U.S. Cl. 705/319

(57) ABSTRACT

A new algorithm is introduced to compare different transportation routes. Using the formula a special indicator I is calculated online. For the purpose of the Invention I may fluctuate from 0 to 1. If it is zero the two routes are fully matched, they are same routes. If I>1 there is no match at all. The smaller is I the better is the match. Based on this algorithm a Social Networking website is created connecting people on the move with different services providers and between themselves.

By communicating with service providers customers may find the most efficient match for their next ride or move, or freight and save substantial money. On the other side Providers can drastically reduce the amount of empty trips and make additional money too.

The Network may also be used to create and develop carpools and vanpools. The ultimate goal of the Invention and of this Network for Movers is to reduce Traffic and Pollution around the World.

### FIELD OF THE INVENTION

The present invention provides a method and system of using Social Networking for the purpose of effectively matching supply and demand in transportation, moving, shipping, vanpooling and carpooling.

### BACKGROUND OF THE INVENTION

Traffic is a major problem of big cities around the world. In the USA the traffic congestion cost is estimated at $114.8 billion in 2009 just in lost time and fuel as the average urban driver spent the equivalent of four work days waiting in cars, according a report by Texas Transportation institute. In addition the related public health cost is conservatively $18 billion a year (HCRA—Harvard Center for Risk Analysis). In the developing, so called BRIC countries (Brazil, Russia, India and China) the problem of traffic congestion is much bigger.

A lot of money had been spent on traditional solutions like building new roads and bridges, introducing new traffic lights and regulations, restricting access to certain areas, encouraging use of public transportation and carpooling, etc. All of the above helps temporarily but does not rectify the situation. The problem is growing faster with every passing year, creating traffic nightmares.

One of the major causes of traffic problems is so called “empty trips” of trucks, taxies, car services and limousines. As New York Times reported on Apr. 21, 2010 more than a quarter of the trucks on the road in the United States drive empty, according to industry estimates. Figures produced by Eurostat show that one in four of the trucks traveling on Europe's roads is empty. Similar situation is with passenger car and limo services.

Typically, a customer who desires to reserve a vehicle for transportation or moving purposes is contacting a local provider to obtain a price quote and make a reservation. Usually the provider must dispatch a vehicle to the departure location. Also, if the destination is remote from any pickup presently scheduled by the provider, the vehicle must often return without any customers to an area where another customer can be serviced. Consequently, such providers as car and limousine services, taxis, or trucking companies, often have a vehicle traveling to another job without a paying customer. This is the source of all those empty cars and trucks on the roads. Fares and freight charges also must be adjusted to compensate the provider for those periods when the vehicle will be traveling without any paying customer.

In order to reduce travel of the vehicles without paying customers the present invention introduces a special algorithm allowing to measure quantitatively similarity of different routes. Based on the algorithm a special Social Network was created. Registered users of this network can enter their respective desired routes in the database and see the routes of the other side in order of their similarity. Then the customers and providers of services use this information to strike mutually beneficial deals.

### SUMMARY OF THE INVENTION

According to present invention a method and system is provided to match interactively in the most efficient way customers and providers of transportation, moving and shipping services. Registered customers enter their pick up location, destination and time of the departure in the Customers' Database. The data is instantaneously compared with Providers' Database in search of vehicles available at the departure time within a distance less than the length of the customer's route. Each of the found provider's vehicles has a projected desired route. The system compares those routes with the customer's route and calculates so called Indicator Icr described here down in detail. All vehicles with Icr between 0 and 1 appear on the customer's page with contact information. The most identical routes (with smaller I) appear first. The customer may contact the provider and make a deal.

Similar procedure is taking place with Providers. Registered providers enter their pick up location, destination and time of the departure in the Providers' Database. The data is instantaneously compared with Customers' Database in search of customers with the same departure time within a distance less than the length of the customer's route. Each of the found customers has a projected desired route. The system compares those routes with the provider's route and calculates so called Indicator Icr described here down in detail. All customers with I between 0 and 1 appear on the provider's page with contact information. The most identical routes (with smaller Icr) appear first. The provider may contact the customer and offer a deal. The provider also may be contacted by customer first.

In case of carpooling and vanpooling the data is entered, evaluated and compared in similar way. The difference is that the distance between departure points of comparable routes must be less than one third of the shorter route.

The mathematical foundation of the invention is indicator Icr (FIG. 16, page 20):

Ac—Zc is the customer's order route.

Ap—Zp is the provider's wish route.

Lc is the length of the customer's route.

Lp is the length of the customer's route

a—is the distance between customer's pick up location and the provider.

z—is the distance between customer's drop off location and provider's wish destination.

$$Icr = \frac{a + z + Lc}{Lp} - 1$$

If a=z=0 this means that the routes coincide, they are the same. Ideal situation. The closer Icr is to zero the better.

If Icr>1 the routes are excluded from consideration for matches.

### BRIEF DESCRIPTION OF THE DRAWINGS

The description herein makes reference to the accompanying drawings:

FIG. 1 schematically illustrates the overall system of present invention;

FIG. 2 through FIG. 3 is a flow chart illustrating the general rules of using the system of present invention;

FIG. 4 through FIG. 6 is a flow chart for the software of the operating system as utilized by a customer seeking transportation, moving or shipping services;

FIG. 7 is a flow chart for the software of the operating system as utilized by a provider seeking customers for transportation, moving or shipping services;

FIG. 8 is a flow chart for the software of the operating system as utilized by a customer seeking vanpool or carpool;

FIG. 9 is a flow chart for the software of the operating system as utilized by a vanpool provider seeking customers for his services;

FIG. 10 is the home page of the Social Networking website of the present invention used by customers;

FIG. 11 is the home page of the Social Networking website of the present invention used by service providers;

FIG. 12 is an exemplary page of the Social Networking website of the present invention after required information is entered by customer;

FIG. 13 is an exemplary page of the Social Networking website of the present invention after required information is entered by service providers;

FIG. 14 is an exemplary page of the Social Networking website of the present invention after required information is entered by customer seeking carpool or vanpool;

FIG. 15 is an exemplary page of the Social Networking website of the present invention after required information is entered by vanpool providers;

FIG. 16 is a diagram, related to the description of the Mathematical Foundation of the Invention

### DESCRIPTION OF THE PREFERRED EMBODIMENT

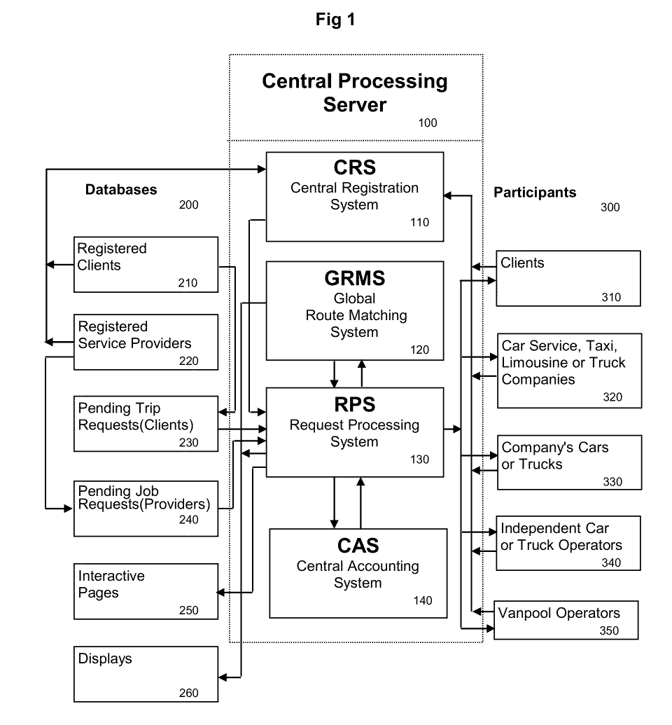

The present invention is utilized by Social Networking website AZALog.com. The system is available online and through plurality of mobile devices. As shown on FIG. 1 the Central Processing Center 100 (CPS) includes a Global Routing Matching system (GRMS) 120 and Request Processing System (RPS) 130. The two systems receive information from different databases and exchange information between themselves. As a result of all those exchanges and processing the matched routes are displayed on clients and providers pages with all relevant information to approach each other and make a mutually beneficial decision.

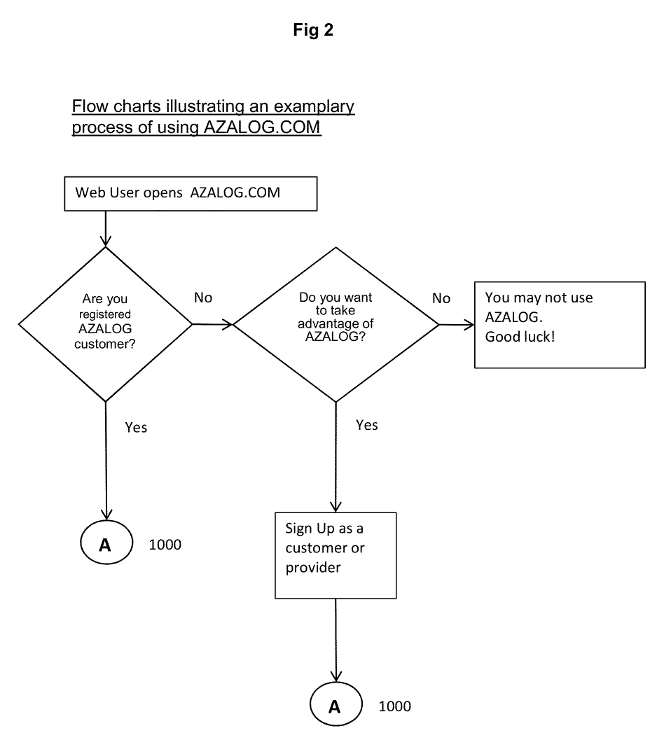

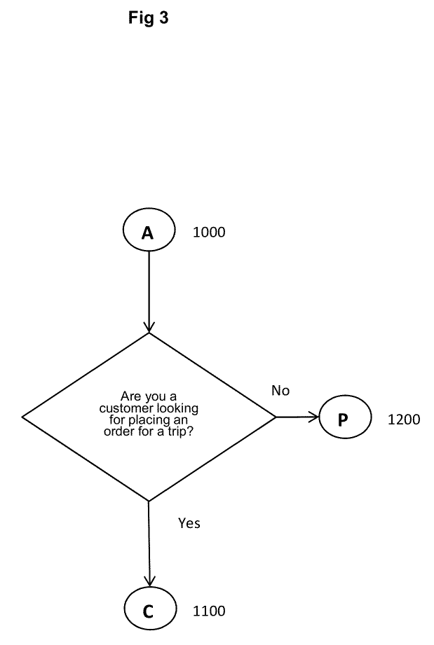

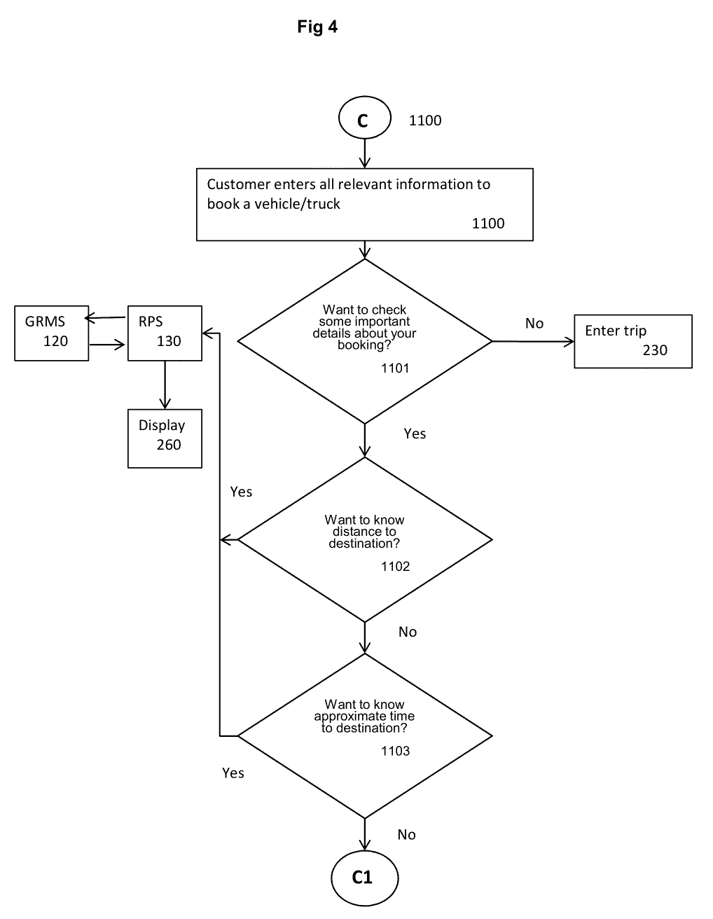

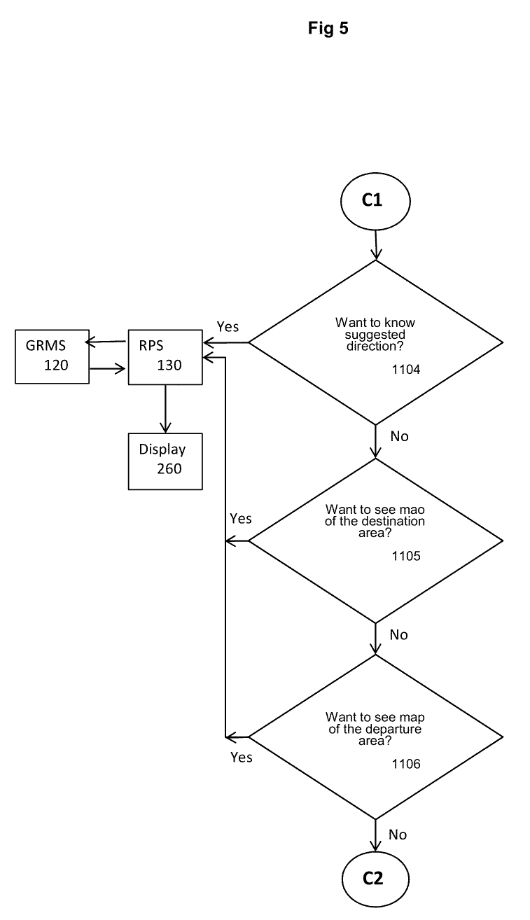

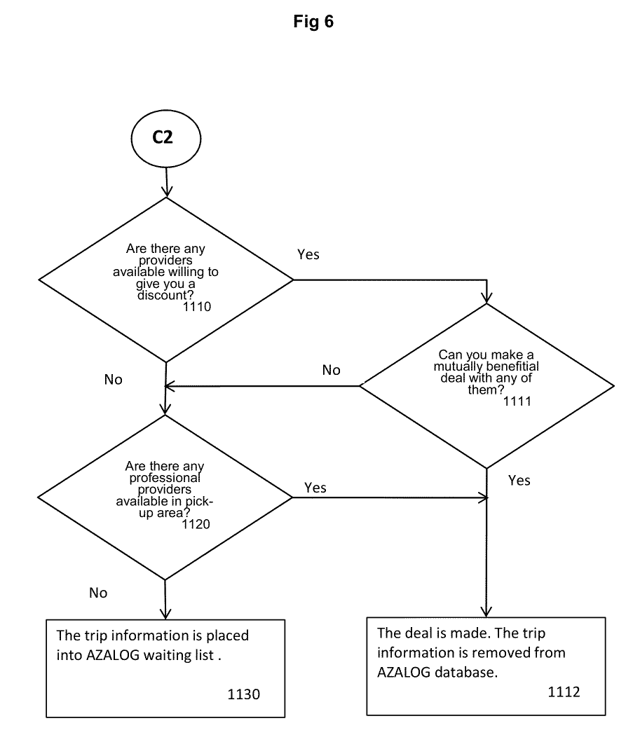

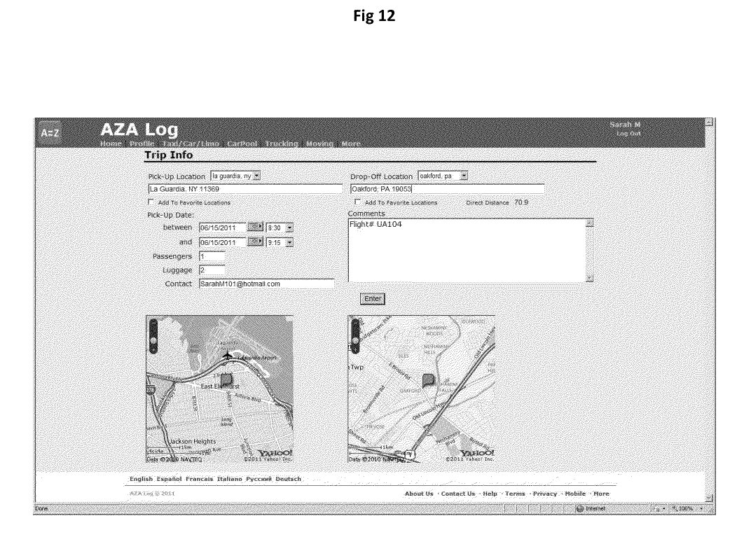

FIGS. 2 through 9 illustrate the system of present invention in flow charts of exemplary use of AZALog.com by customers and providers of services. FIG. 2 shows that only registered customers can take advantage of the system. Customers and providers use different pages to enter their relevant information. FIGS. 4 to 6 illustrate the use of the site by customers after entering their trips in the database (230). FIG. 6 shows the options customers have after entering their potential orders. The preferable option is to find a provider ready to give a discount (1112). Such providers (if any) will appear on customer's page in the order of their relevance (FIG. 12)

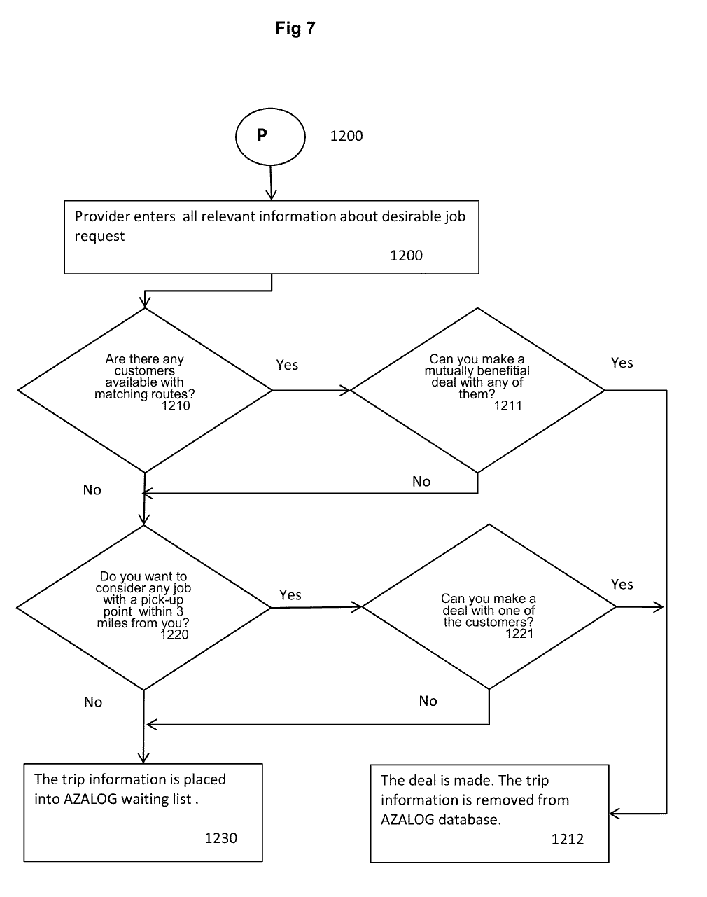

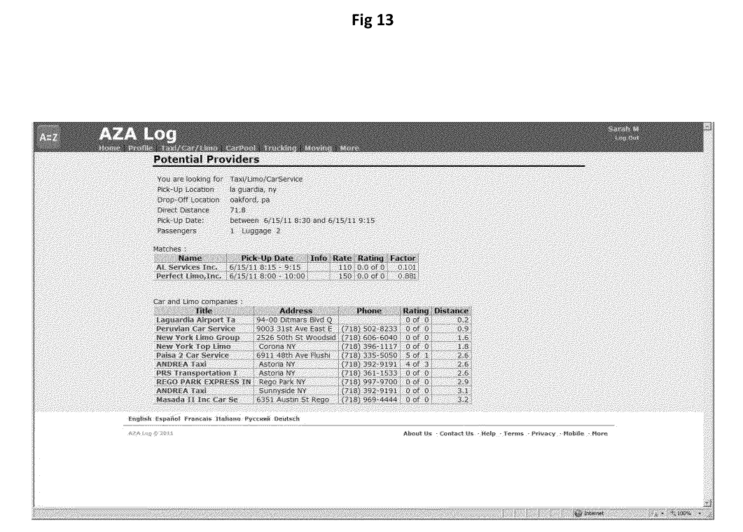

FIG. 7 shows the flow chart and the options given by the system to providers after they entered their pending job requests in the database (240). The preferable option is to find a customer with a matching route (1212) and avoid an empty trip. Such customers (if any) will appear on provider's page in the order of their relevance (FIG. 13)

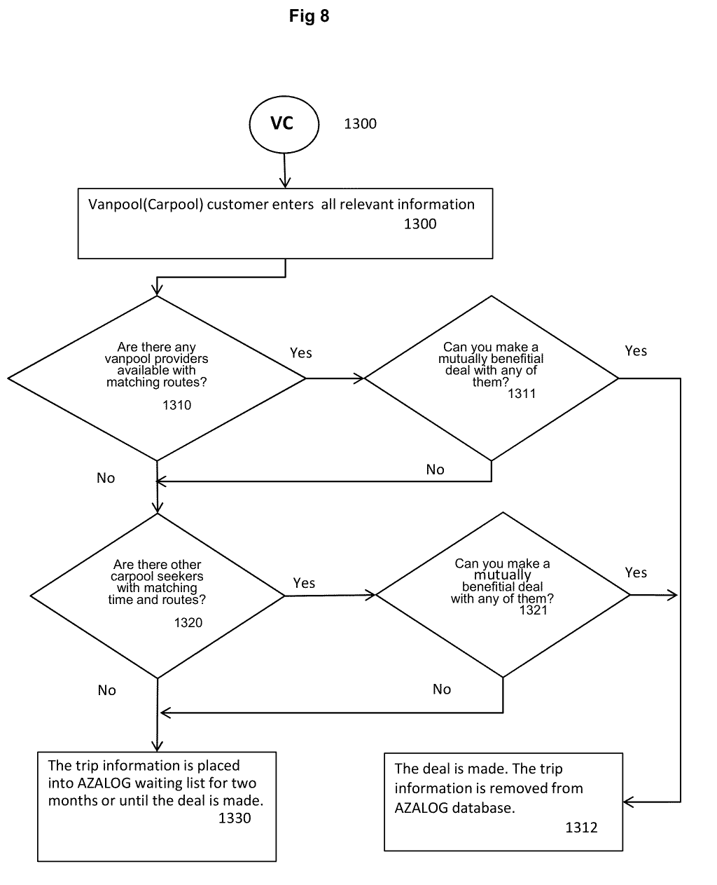

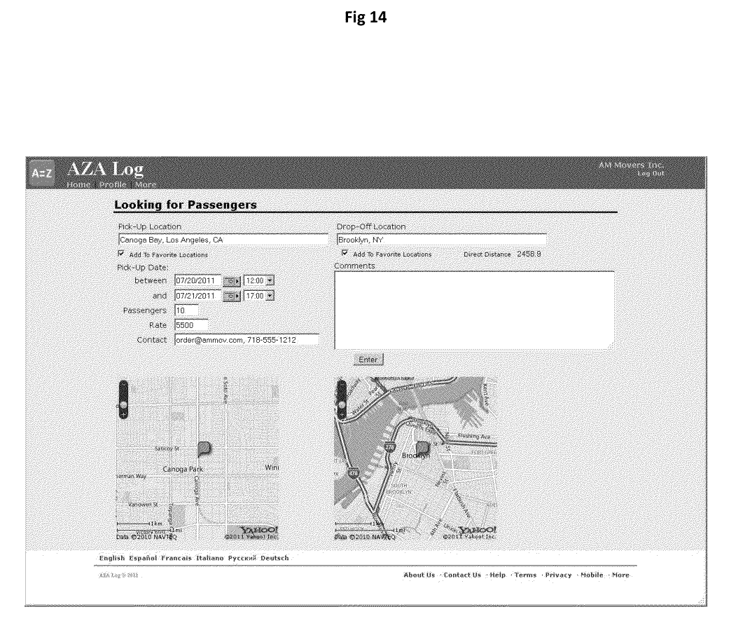

FIG. 8 shows the flow chart and the options provided by the system to users seeking carpools or vanpools after they entered their requests in the database (1300). The preferable option is to find a carpool provider with a matching route (1312) or a carpool seeker with a matching route (1322). Such options (if any) will appear on user's page in the order of their relevance (FIG. 14)

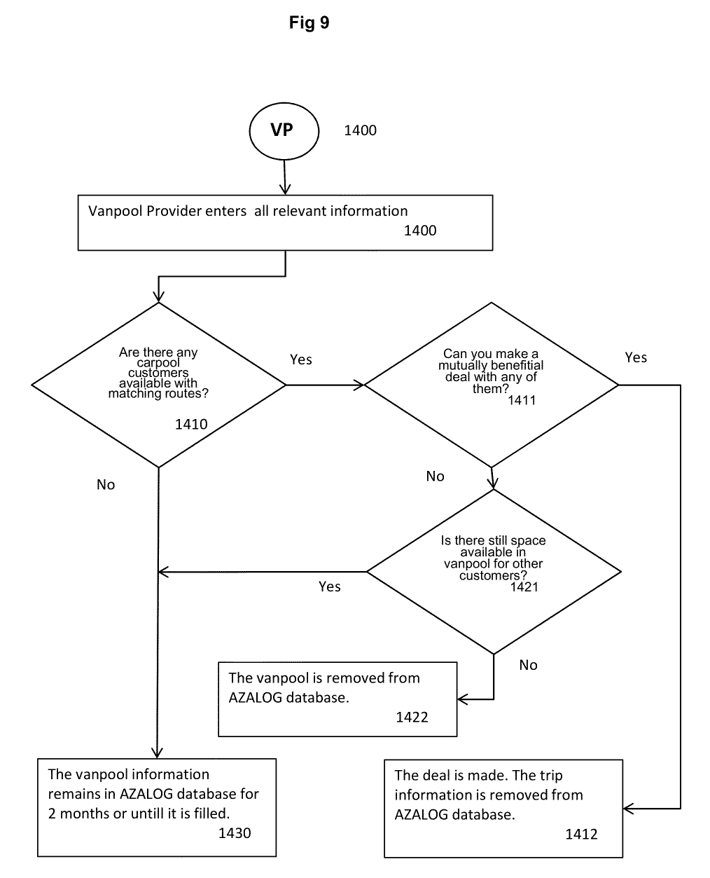

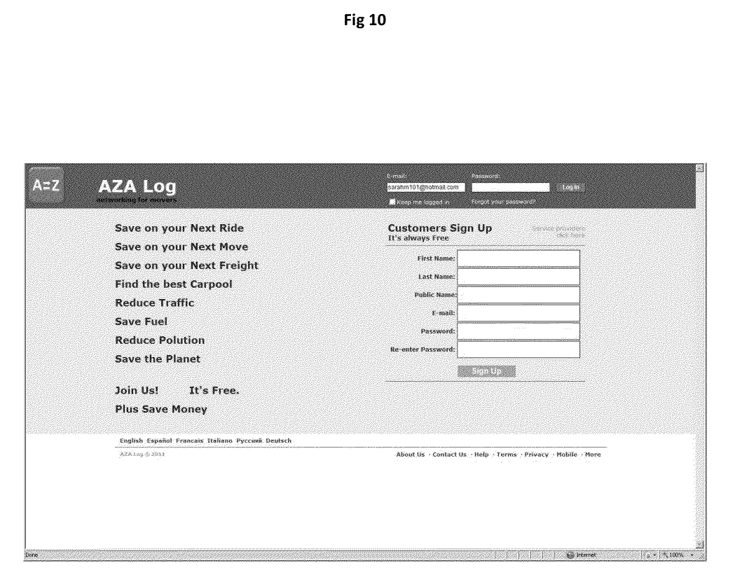

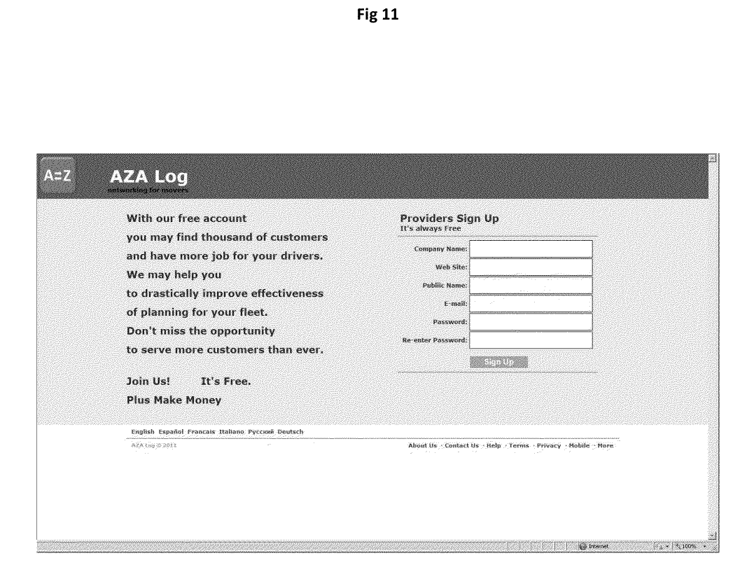

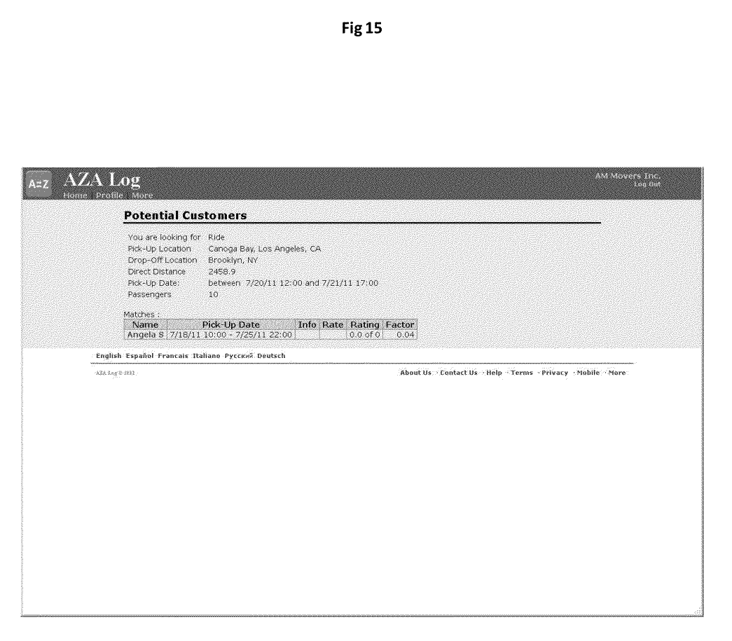

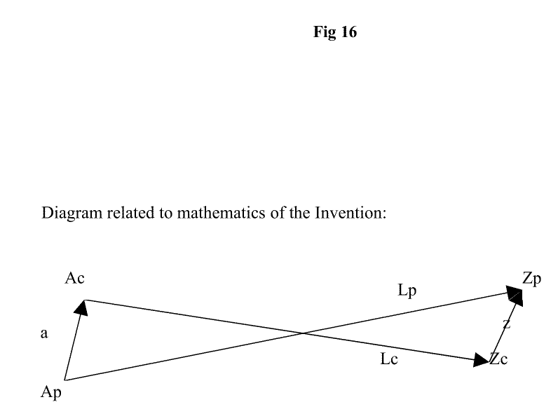

FIG. 9 shows the flow chart and the options given by the system to vanpool providers after they entered their vanpool routes in the database (1400). The preferable option is to find a vanpool seeker with a matching route (1412). Such seekers (if any) will appear on vanpool provider's page in the order of their relevance (FIG. 15)

Finally two practical exemplary cases.

Case 1. John is going from Philadelphia to JFK airport in New York at 6:15 am on June 15. He has booked his trip with AL Services (ALS) in his neighborhood a day earlier. ALS immediately went to AZALog.com and entered the desired return trip from JFK to Philadelphia for June 15 from 8:15 am till 9:15 am in the providers' database. Sarah is coming to La Guardia airport in New York at 8:00 am on June 15, and she wants to go to Oakford, PA. Sarah enters this trip in customers' database from 8:30 am to 9:15 am. (She needs some time for luggage delivery, passport control, customs, etc.). Sure enough the ALS return trip appeared on Sarah's page first (FIG. 12) (The Icr indicator was 0.101). Sarah contacted ALS and made a deal for $110. The driver picked her up at La Guardia (12 miles from JFK) and delivered home in Oakford (4.8 mi from ALS base). Sarah saved $90 (Regular fare is $200). ALS made additional $110. And one car less was on the road for about 4 hours. Good for Sarah, good for ALS, good for the environment.

Case 2. Alex was going to move from Brooklyn, NY to Canoga Bay, Los Angeles approximately on Jul. 12, 2010. He has to take everything from his 3 bedroom apartment including his piano. He called up several professional movers, ending up placing the order with AM Movers for $7,500 (it was a good deal!). Estimated delivery date—July 20. Angela was going to move from Oceanside blvd., Oceanside, Calif. to Philadelphia, Pa. after July 18 and entered her moving trip in customers' database of AZALog.com. The potential order appeared first on AM Movers page (FIG. 13) like potentially matching route for their return trip from Los Angeles (Icr was 0.042). AMM contacted Angela and offered her a great deal, she saved $2,000. AMM gave her a big discount to avoid a long empty trip. They still made $5,500. And for about 20 days it was one big truck less on the roads of the country.

Good for Angela, good for AM Movers, good for the world.

What is claimed is:

1. A method and system of comparing and matching transportation routes on the internet was developed, leading to creation of Social Networking website connecting people on the move with different services providers and between themselves;
by communicating with service providers customers find the most efficient match for their next ride, or move, or cargo shipping;
by communicating with customers providers find the most efficient match for their return or intended trips, thus drastically reducing so called empty trips;
by communicating between themselves and vanpool providers customer find or develop the most efficient carpools and vanpools;
by finding efficient matches for their moves and routes people are significantly reducing traffic and pollution.

2. The method of claim 1 further comprising the step of:
introducing an algorithm for calculating indicator Icr (indicator for comparing routes);
said indicator for the purpose of the invention may fluctuate from 0 to 1;
if Icr=0 the routes are totally matched (same routes);
if Icr>1 there is no match at all, and there is a need to look for another route for comparison.

3. The method of claim 2 further comprising the step of:
using the data entered by users and other publicly available geographical data Icr is automatically calculated for any two routes presented for comparison.

4. The method of claim 1 further comprising the step of:
customers entering their pick up locations, date and time in the customer's database;
said data is instantaneously compared with provider's database for the vehicles located within a distance from pick up location which is less than the length of the customer's route; for each of such providers indicator Icr is calculated;
all relative information about such providers is displayed on the customer's page in order of their relevancy: the smaller Icr comes first.

5. The method of claim 4 further comprising the step of:
customers are contacting providers in the order of their display trying to make the best possible choice.

6. The method of claim 1 further comprising the step of:
providers entering their start up locations, date and time range in the provider's database;
said data is instantaneously compared with customer's database for the customers located within a distance from start up location which is less than the length of the customer's route; for each of such customers indicator Icr is calculated;
all relative information about such customers is displayed on the provider's page in order of their relevancy: the smaller Icr comes first.

7. The method of claim 6 further comprising the step of:
providers are contacting customers in the order of their display trying to make the best possible deal.

8. The method of claim 1 further comprising the step of:
customers entering their start up locations, dates and time in the customer's database;
said data is instantaneously compared with other customers looking for carpool and vanpool providers within a distance from pick up location which is less than the one third of the length of the customer's route;
for each of such customers or vanpool providers indicator Icr is calculated;
all relative information about such customers or vanpool providers is displayed on the customer's page in order of their relevancy; the smaller Icr comes first.

9. The method of claim 8 further comprising the step of:
customers are contacting other customers or vanpool providers in the order of their display trying to make the best possible choice for carpool or vanpool.

10. The method of claim 1 further comprising the step of:
the method and system of matching transportation routes online and created on its basis Social Network for movers is fully adoptable for use on mobile phones and other mobile devices.
